(19) United States
(12) Patent Application Publication
(10) Pub. No.: US 2002/0194214 A1
(43) Pub. Date: Dec. 19, 2002

(54) Management method and management system for image forming device

(75) Inventor: Jun Fukazawa, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/173,006

(22) Filed: Jun. 18, 2002

(30) Foreign Application Priority Data
Jun. 19, 2001 (JP) 2001-185010
May 15, 2002 (JP) 2002-139956

(51) Int. Cl. G06F 15/00

(52) U.S. Cl. 707/500

(57) ABSTRACT

A method and a device for managing an image forming device by a management device connected therewith via a communication line. A terminal provided on the image forming device records operating information, and collects monitoring information corresponding to the operating information by monitoring the image forming device from the outside, so that the operating information and the monitoring information are transmitted to the management device via the communication line. The management device administers the image forming device and transmits coping information necessary for the image forming device to the terminal on the image forming device based on the operating information and the monitoring information. When the operation of the image forming device is abnormal, it can be dealt with quickly and accurately achieving a reduction in the period of analyzing the cause of the abnormality and repairing the image forming device.

### BACKGROUND OF THE INVENTION

1. Field of the Invention

The present invention relates to a management method and a management system for an image forming device. More specifically, it relates to a management method and a management system for an image forming device for managing, via a network, the operation state and the like, of the image forming device, which forms an image based on inputted image data.

2. Description of the Related Art

Recently, image forming devices utilizing digital exposure have been proposed as an image forming device for reading an image recorded on a film to execute a reproduction process, that is, a process for printing a photograph. According to this image forming device utilizing the digital exposure, an image recorded on a film is read photoelectrically by photoelectric transfer so as to obtain inputted image data. Various kinds of image processes are then applied so as to obtain processed image data. A photosensitive material is scanned and exposed by a light for recording, which light is modulated according to the processed image data, to record an image (latent image), which is developed to output a photographic print.

Using this image forming device, a film is read photoelectrically, and color density correction is executed by a signal process so as to determine exposure conditions. Therefore, an efficient operation can be executed since it is unnecessary for an operator to determine the exposure conditions, adjust a filter, or the like, at the time of exposure, and the exposure time is constant according to image size. Moreover, compared with the conventional print obtained by directly exposing a film, a print can be outputted with a higher image quality in terms of resolution, color/density reproductivity, and the like. Therefore, the image forming device using the digital exposure is used widely.

However, when an operation inoperable state or operation abnormal state, such as when the image quality of an image to be printed and outputted is reduced, for example, a quick analysis of the cause of the operation inoperable state or the abnormal state, a repair of the image forming device and a reduction of the repair costs are desired.

Therefore, when the operation abnormality or the operation inoperable state, such as a malfunction, occurs in the image forming device, a user of the image forming device makes a telephone inquiry or the like, to a predetermined servicing center, to explain the present state of the image forming device and obtain an appropriate coping method therefrom. Or the user diagnoses and administers the image forming device by referring to an instruction manual, or the like, provided with the image forming device.

However, when the image forming device is diagnosed and managed by the conventional manner, the following problems are generated. That is, for example, when the user makes the telephone inquiry to the servicing center, the explanation of the process of the operation, the operation situation, or the like of the image forming device can be insufficient, such that it is difficult to gasp the state of the image forming device quickly and accurately. Thus, there is a risk of requiring a long time to analyze the cause of the generation of the operation abnormal state, or the like, so as to prolong the period such as the repair period, for coping with the operation abnormal state.

Moreover, although a method of dealing with the operation abnormal state by referring to the instruction manual of the image forming device is conceivable, in reality, the instruction manual is inconvenient and does not always include all necessary information. Furthermore, even when the necessary information is included, much time is needed to look up the necessary information in somewhere in the manual. Consequently, the analysis of the cause of the generation of the operation abnormal state, the repair period, or the like is prolonged.

### SUMMARY OF THE INVENTION

In order to solve the above-mentioned problems, the present invention has been achieved, and an object thereof is to provide a management method and a management system for an image forming device capable of dealing with generation of an operation abnormal state, or the like, of the image forming device quickly and accurately, and reducing the time required for analyzing the cause of generating the operation abnormal state or the operation inoperable state and repairing the image forming device.

In order to achieve the above-mentioned object, a first aspect of the present invention provides a management method for an image forming device for managing an image forming device, which forms an image based on inputted image data, by a management device connected therewith via a communication line, comprising the steps of: recording operating information in a recording medium, which operating information shows an operation state of the image forming device; monitoring the image forming device from outside the device and collecting monitoring information; transmitting the operating information and the monitoring information to the management device via the communication line; and managing the image forming device based on the received operating information and the received monitoring information.

The image forming device is managed via the communication line. Since it is preferable to grasp the operation state of the image forming device while managing the image forming device, the operating information related to the operation state of the image forming device is recorded. The operating information is information capable of numerically or quantitatively representing how the appliances comprising the image forming device are operated during the operation of the image forming device. More specifically, the speed, the temperature, the time, or the like, are included in the operating information. By recording the operating information and referring to the recorded operating information, when and how the image forming device was operated with respect to inputted image data, the content of processes in the image forming device, the time needed for the processes, or the like, can be grasped. Moreover, whether or not the image forming device was operated appropriately can easily be judged.

Since exact management can be enabled by using a larger amount of information as the base of the management of the image forming device, it is preferable to collect monitoring information that monitors the image forming device from the outside, and corresponds to the operating information. In order to grasp the operation state of the image forming device from the outside, the information of the phenomena that is generated in the image forming device, which information is collected from the outside directly and physically, and the information on the physical amount representing the operation state of the image forming device indirectly, can be provided as the monitoring information. Accordingly, by collecting the information of the image forming device from the outside in addition to the data on the operation of the image forming device itself, and referring to the collected information, for example, the operation state such as the state of operation of the image forming device by an operator can be monitored so that the image forming device can be managed more exactly.

The operating information and the monitoring information are transmitted to a management device for managing the image forming device. By receiving the information, since the management device can obtain the above-mentioned different kinds of information for the image forming device based on the operating information and the monitoring information, the management items can be extracted for each of the information so that a more exact management of the image forming device can be enabled.

The operating information can be an operation history comprising a plurality of operation data for a predetermined period as a unit.

In consideration of the information management convenience, or the like, it is preferable that a large number of data can be referred to. Then, as to the operating information, an operation history for a predetermined period, such as a plurality of operation data from a start of the operation of the image forming device to an end of the operation is made into a unit. By making a plurality of the operation data in a predetermined period into a unit, the operation situation and the operation trend of the image forming device can easily be grasped and the data amount of the operating information is reduced, facilitating the management of the operating information.

The operating information may include the error generated information, which is generated in the image forming device.

In the operation of the image forming device, an error state hindering the operation may be generated. However, since the operating information is produced regardless of whether or not an error is generated in the image forming device, it is necessary to consecutively check whether or not an error is generated. Therefore, by including error generated information in the operating information, when an error is generated, whether or not an error is generated can be grasped and confirmed in an early stage. Moreover, by referring to both the error generated information and the operation history in the operating information, the situation of the error generation, such as the particulars of the error generation, can easily be grasped.

The monitoring information may be information for monitoring the image forming device by at least one of sound and video.

In order to monitor the image forming device from the outside, since collection of the sound in the environment of the image forming device installation site or visual observation of the same is the easiest and most direct way, information for monitoring the image forming device by at least one of sound and video is adopted as the monitoring information. By adopting the information for monitoring the image forming device by at least one of sound and video, for example, according to the video information, the operation state by the operator and external deterioration of the image forming device can be grasped visually. Moreover, according to the sound information, whether or not the image forming device generated an abnormal noise during the operation, or the like can be grasped. The monitoring information may include information concerning the temperature, the humidity, existence or absence of vibration, or the like in the installation environment of the image forming device. Furthermore, correspondence of the operating information and the monitoring information can be executed either per process of the image forming device or per a length of operation time.

The management device may transmit coping information showing the correspondence from the operating information and the monitoring information to the image forming device.

In the management of the image forming device, it may be preferable to respond to the image forming device. For example, when an error is generated in the image forming device, a process for coping with the error needs to be executed. In this case, it is preferable to have a response such as an appropriate designation. Therefore, the management device transmits the information related to the received operating information and monitoring information, showing the correspondence between the information and the image forming device. In the image forming device, based on the transmitted coping information, for example, an appropriate operation process such as a processing for the error can be executed.

The above-mentioned method can be realized by a management system for an image forming device as a second aspect of the present invention. The second aspect of the present invention is a management system for an image forming device that forms an image based on inputted image data, for managing the image forming device by a management device connected therewith via a communication line, the system comprising: (1) a terminal device disposed at the image forming device, the terminal device including recording means for recording operating information, which shows an operation situation of the image forming device, monitoring information collecting means for collecting monitoring information, which is obtained by monitoring the image forming device from the outside and made to correspond to the operating information, transmitting means for transmitting the operating information and the monitoring information to the management device via the communication line; and (2) a management device including receiving means for receiving, via the communication line, the transmitted operating information and the transmitted monitoring information, and storing means for storing the received operating information and the received monitoring information.

The management device may further include a display means for displaying the operating information and the monitoring information.

In the invention, the image forming device is managed by the management device connected therewith via the communication line. In management of the image forming device, since it is preferable to grasp the operation state of the image forming device, the operating information concerning the operation state of the image forming device is recorded in the terminal device of the image forming device by the recording means. Moreover, since the more exact management can be enabled with a large amount of the information as the basis of the management of the image forming device, the terminal device of the image forming device collects the monitoring information obtained by monitoring the image forming device from the outside, which monitoring information corresponds to the operating information by the collecting means. Then, in order to administer the image forming device remotely, the operating information and the monitoring information are transmitted by the transmitting means to the management device via the communication line. The management device receives the operating information and the monitoring information using the receiving means. By transmitting the information by the terminal device via the communication line so that the information is received by the management device via the communication line, the management device can obtain specifically the above-mentioned kinds of information for the image forming device based on the operating information and the monitoring information remotely. Moreover, the management device may display the information on the display means so that the operating information and the monitoring information are easily grasped and confirmed. In the management device, by displaying the operating information and the monitoring information on the display means, for example, an operator can grasp the operating information and the monitoring information visually. The management device can extract management items for each kind of the information so that a more exact management of the image forming device can be enabled.

In the terminal device, an operation history, which makes record with a plurality of operation data in a predetermined period into a unit, can be recorded as the operating information by the recording means.

In consideration of a convenience of the information management, or the like, as the operating information, the operation history with a plurality of operation data in a predetermined period, for example, from the start of the operation of the image forming device to the end of the operation as a unit is recorded in the recording means as the operating information. By making a plurality of the operation data in a predetermined period into the unit, the operation situation and the operation trend of the image forming device can easily be grasped so that the data amount of the operating information is reduced, facilitating the management of the operating information.

The management device may accumulate an operation history, which makes a plurality of operation data for a predetermined period with respect to the received operating information into a unit, in the memory means as the operating information.

In consideration of the information management convenience, or the like, as the operating information, an operation history, which makes a plurality of operation data in a predetermined period, for example, from the start of the operation of the image forming device to the end of the operation into a unit, can be used as the operating information. By receiving and accumulating the plurality of the operation data for the predetermined period as the unit as the operating information, or accumulating the received operating information with a plurality of the operation data for the predetermined period as a collective unit, the operation state can be grasped and the operation trend of the image forming device can easily be grasped, the data amount of the operating information can be reduced, facilitating the management of the operating information.

In the terminal device, the recording means can record error generated information, which is generated in the image forming device, as the operating information.

Since the operating information is produced and recorded regardless of whether or not an error is generated in the image forming device, it is necessary to check whether or not an error is generated consecutively. Therefore, the error generated information is included and recorded in the operating information in the case an error is generated. Thereby, whether or not an error is generated can easily be grasped and confirmed in an early stage. Moreover, by referring to both the error generated information and the operation history in the operating information, the situation of the error generation such as the particulars of the error generation can easily be grasped.

In the management system of the image forming device, it is preferable that the collecting means for the monitoring information of the terminal device comprise at least one of a sound means for collecting sound information and a video means for collecting video information.

In order to monitor the image forming device from the outside, since collection of the sound in the environment of the image forming device installation site or visual observation of the same is the easiest and most direct way, at least one of a sound means for collecting the sound information as the monitoring information and a video means for collecting the video information as the monitoring information is collected as the monitoring information. By collecting at least one of the sound information and the video information as the monitoring information, the operation state by the operator and external deterioration of the image forming device can be grasped visually from the video information, for example. Moreover, according to the sound information, whether or not the image forming device generated an abnormal noise during the operation, or the like can be grasped. Correspondence of the operating information and the monitoring information can be executed either per each process by the image forming device or per length of operation time. The correspondence may be executed either at the time of recording or at the time of collecting the sound information or the video information.

In the management system for an image forming device, the terminal device may further include an information receiving means for receiving information via a communication line, and the management device may further include an outputting means for outputting the coping information to the image forming device from the operating information and the monitoring information, and a transmitting means for transmitting the coping information to the terminal device.

In management of the image forming device, in some cases it is preferable to respond to the image forming device from the management device. For example, when an error is generated in the image forming device, it is preferable to respond with a process corresponding to the error. Therefore, predetermined information is received in the terminal device via the communication line by the information receiving means. Thereby, for example, processing information corresponding to the error, or the like can be received at the terminal device. Moreover, since the management device grasps the operation state of the image forming device by receiving the operating information and the monitoring information of the image forming device, the management device transmits the information showing correspondence of the information with the image forming device, that is, a process corresponding to the error, or the like, in relation to the received operating information and monitoring information. The image forming device can execute the operation process, such as the process corresponding to the error, based on the transmitted corresponding information.

In the management system for an image forming device, the terminal device may further include an operating means for operating the image forming device, and the management device may comprise a transmitting means for transmitting the operation information as the coping information.

When operating the image forming device or executing the processing operation corresponding to the error, or the like, remotely, an operating means is necessary in the terminal device. Then, the terminal device comprises a operating means for operating the image forming device. Since the command information for the operation is needed in the operating means, appropriate operation information is outputted by the outputting means in the management device. Thereby, the image forming device can be operated by the remotely disposed management device.

The management method for an image forming device can easily be realized by executing a management program stored in a memory medium by a computer as well as the medium can be provided in a portable form. Specifically, the memory medium is a memory medium storing a management program for an image forming device capable of forming an image based on inputted image data. The recording medium on which computer executable-instructions are recorded for performing processing on a computer comprising the steps of: recording operating information concerning the operation state of the image forming device; collecting the monitoring information obtained by monitoring the image forming device from the outside; corresponding to the operating information; and transmitting the operating information and the monitoring information to a management device for managing the image forming device via a communication line. Moreover, for the management device, it is a memory medium storing a management program for an image forming device for managing the image forming device based on the received operating information and monitoring information.

### BRIEF DESCRIPTION OF THE DRAWINGS

FIG. 1 is a conceptual diagram showing an example of a management system for an image forming device according to an embodiment of the present invention.

FIG. 2 is a block diagram showing an example of a system configuration of a photo-shop (processing laboratory) having an image forming device managed by the management system for the image forming device according to the embodiment of the present invention.

FIG. 3 is a schematic configuration diagram of the image forming device shown in FIG. 2.

FIG. 4A is a flow chart showing a flow of a process in the image forming device, which is managed by the management system for the image forming device according to the embodiment of the present invention, and FIG. 4B is a flow chart showing a flow of a process at a call center, which administers the image forming device by the management system for the image forming device according to the embodiment of the present invention.

FIG. 5A is a flow chart showing a process on the image forming device side according to another embodiment, and FIG. 5B is a flow chart showing a process on the call center side.

### DESCRIPTION OF THE PREFERRED EMBODIMENT

[First Embodiment]

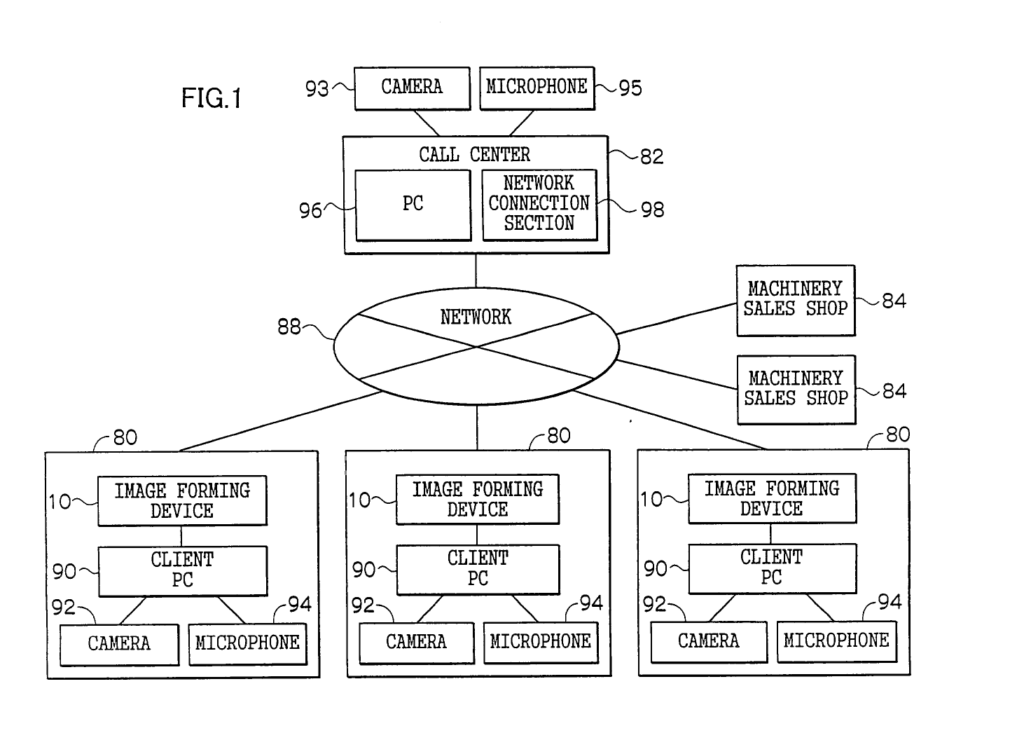

Hereinafter, an embodiment of the present invention will be explained with reference to the drawings. FIG. 1 shows a schematic configuration of a management system for an image forming device 10 according to a first embodiment of the invention. As shown in FIG. 1, the management system for the image forming device 10 comprises: a so-called photo-shop (processing laboratory) 80 having the image forming device 10; a call center 82 connected with the photo-shop 80 via a network 88; and a retail shop 84, which sells the image forming device. The photo-shop 80, the call center 82, and the retail shop 84 for the image forming device can send or receive information by mutual communication via the network 88, which is used as a communication line.

The photo-shop 80 comprises a client PC 90 as a terminal device, the image forming device 10, a camera 92 as a video inputting means, and a microphone 94 as a sound inputting means. The client PC 90, the image forming device 10, the camera 92 and the microphone 94 are connected by a predetermined bus so that they can send or receive data to or from each other.

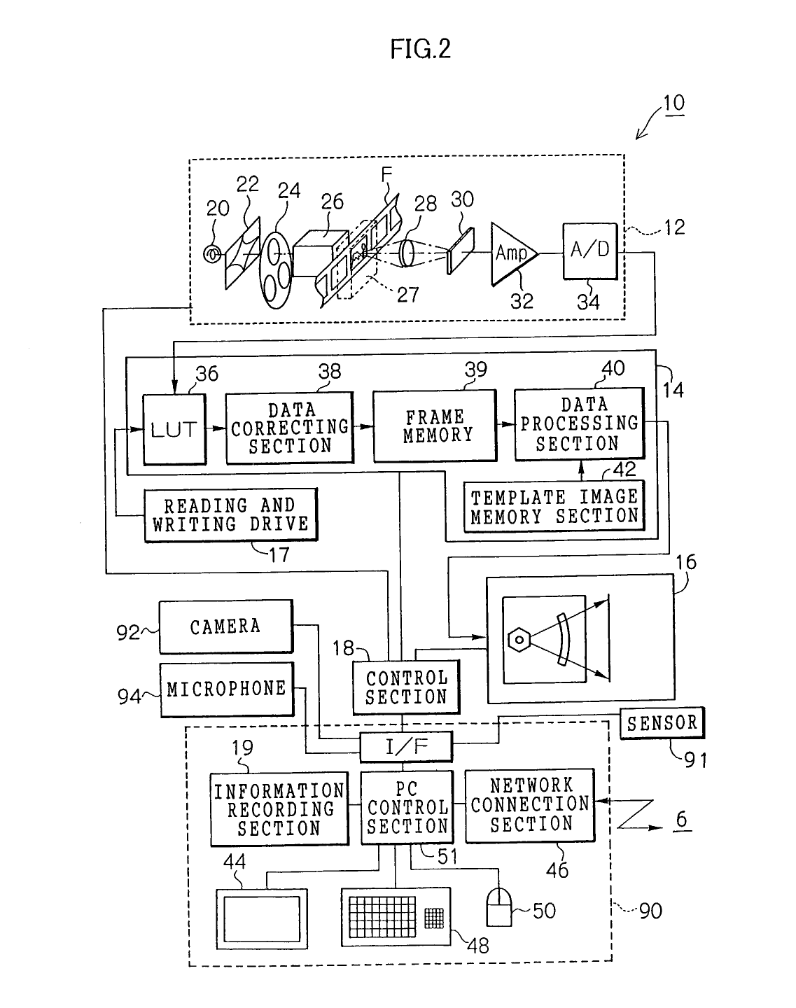

The image forming device 10 prints photographs by reading an image recorded on a film. Specifically, as shown in FIG. 2, the image forming device 10 comprises: a scanner section 12 for photoelectrically reading an image, which is recorded in a film, and outputting image data; an image processing section 14 for applying a predetermined correction process or the like to the image data outputted from the scanner section 12 and collecting this processed image data; a printer section 16 for scanning and exposing a photosensitive material with a light beam modulated according to the processed image data, which is outputted from the image processing section 14, and developing, printing and outputting a print; and a controlling section (not shown) for performing a management, a control, an operation, a communication, and the like for the entire image forming device 10.

The scanner section 12 is an image reading device for photoelectrically reading the image recorded on the film, and comprises: a light source 20; a variable diaphragm 22; and three color filters, one of each of R, G and B, for separating the image recorded on the film into the three primary colors of R (red), G (green) and B (blue); a color filter plate 24 capable of rotating to insert an optional color filter into a reading light path; a diffusion box 26 for making a light incident on the film even on a film surface; a carrier 27 for conveying each frame of the film to a predetermined reading position, focusing lens unit 28 for appropriately focusing light for the reading; a CCD sensor 30 as an area sensor for reading each piece (each frame) of the images recorded on the film; an amplifier 32; and an A/D converter 34.

In the scanner section 12, the light for the reading, which is outputted from the light source 20 has the light amount thereof adjusted by the variable diaphragm 22 to a predetermined diaphragm value; passes through the color filter plate 24 and is color adjusted; and is diffused by the diffusion box 26. By having the light for the reading be incident on the film and transmitted therethrough, a light representing an image recorded in the film can be obtained.

The light transmitted through the film is focused on the light receiving surface of the CCD sensor 30 by the focusing lens unit 28. The light amount received in a predetermined accumulation time is converted photoelectrically by the CCD sensor 30 to read the image.

The focusing lens unit 28 is, for example, a combination of a known zoom lens and a focus adjusting lens for adjusting the magnification and the focus according to the film size or a form of the film (film only, a slide specification, or the like). Moreover, the CCD sensor 30 may be a linear CCD sensor having light receiving element extending one-dimensionally in a direction orthogonal to the film conveyance direction.

An output signal from the CCD sensor 30 is amplified by the amplifier 32, A/D converted by the A/D converter 34 into an image signal, and then transmitted to the image processing section 14.

The image processing section 14 comprises: an LUT (look up table) 36 for LOG converting the obtained image signal into input image data; a data correcting section 38; a frame memory 39 for recording and holding the image data; a data processing section 40; and a template image memory section 42.

The data correcting section 38 applies predetermined processings, such as a DC offset correction, a darkness correction, a shading correction and the like, to the input image data, then transmits the data after the processings to the frame memory 39.

The frame memory 39 is a memory for storing the image data, which has been read by the scanner section 12. The image data are transmitted and recorded successively into the frame memory 39.

The data processing section 40 is a combination of a CPU, a memory, various kinds of image processing software, a dedicated circuit for image processing, and the like. In the data processing section 40, a density histogram production, a calculation of the image characteristic amount, and the like are executed from the image data, to which the correction process was applied in the data correcting section 38, to set various image processing conditions and determine the same via an operator's confirmation. Based on the determined image processing conditions, predetermined image processings, such as a color/density correction, a compression/expansion of a dynamic range having an intermediate gradation (application of the dodging effect by the image process), an electronic variable power process (magnification/reduction of the image), a sharpness processing, or the like, are applied as well. Based on the commands of the operator, one of the template images of the templates recorded in the image memory section 24 is selected and a synthesizing process for synthesizing the image data of the template image is applied to the image data to collect this processed image data.

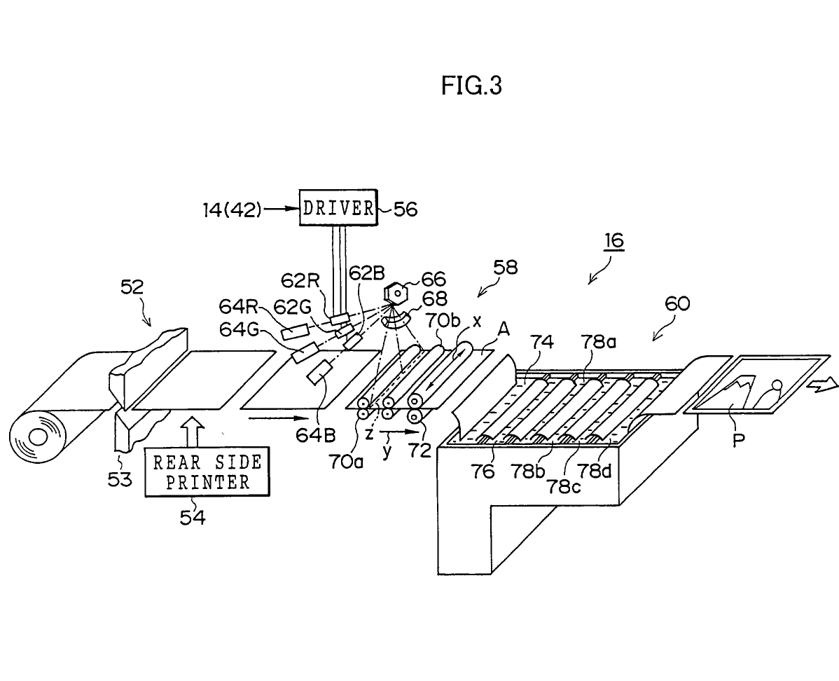

As shown in FIG. 3, the printer section 16 comprises a conveyance section 52, a driver 56, an exposing section 58, and a developing section 60.

The conveyance section 52 comprises: a cutter 53 for cutting, into a predetermined length, a photosensitive material A that is taken out by a conveyance roller 70a and 70b; and a rear side printer 54 for printing the film frame number, the process date, or the like on the rear surface of the image recording surface. The conveyance section 52 conveys the cut, sheet-shaped photosensitive material A, which has been cut into the predetermined length and printed on the rear side, to the exposing section 58.

The exposing section 58 scans and exposes the photosensitive material A with a light beam scan to record an image on the photosensitive material A. The exposing section 58 comprises: light sources 64R, 64G and 64B corresponding to respective photosensitive layers R, G and B of the photosensitive material A, which light sources output a light beam to expose each of the layers; AOMs 62R, 62G and 62B, which modulate the light beam outputted from the respective light sources 64R, 64G and 64B according to each image being recorded; a polygon mirror 62 as an optical polarizer; an fθ lens 68; a sub scanning-conveying means for conveying the photosensitive material A in a sub-scanning direction.

The developing section 60 comprises a color developing vessel 74, a bleaching and fixing vessel 76, water washing vessels 78a, 78b, 78c, 78d, and a drying section. A predetermined process is applied to the photosensitive material A in each of the processing vessels, and the photosensitive material A is dried, and outputted as a print P.

The reading-writing drive 17 is a drive device for: reading image date recorded in a digital image recording medium such, as a flexible disc, an MO, a Zip, and a smart medium, so as to apply a predetermined process with the image processing section 14, and print and output with the printer section 16; and writing, after the image processing, image data in the digital image recording medium.

The control section 18 controls and administers the entire image forming device 10, and inputs various operations, conditions, and the like. Moreover, the control section 18 is connected with the client PC 90 via an interface (I/F) 49 to transmit and receive various data to and from the client PC 90.

The client PC 90 is connected with the image forming device 10 to function as a communication terminal device and an input device for the operation, the conditions, or the like, of the image forming device 10. Moreover, the client PC 90 comprises, for example, a so-called personal computer that is connectable with the network 88, such as the internet, so as to be connected with the call center 82 via the network 88. The client PC 90 comprises: an information recording section 19 for storing various data; a PC control section 51 for controlling the entire client PC 90 and the recording of the various data to the information recording section 19; a key board 48 for inputting numerical values, characters, or the like; a mouse 50 as the pointing device; a display 44 for displaying the inputted and outputted results, or the like; and a network connection section 46 for connecting with the call center 82 via the network 88.

The information recording section 19 (recording means) stores mainly the operating information and the error generated information for the image forming device 10. For example, the kind of the light source 20, a time during which the light is emitted, a current value at the time of the light emission in the scanner section 12, a driving time for the motor, which scans and conveys the film, or the like, are written in the information recording section 19 as the operating information. Moreover, the processing contents in the image processing section 14, such as information on whether or not the color/density has been corrected, whether or not the compression/expansion process of the dynamic range that has the intermediate gradation exists, a size of the image outputted by the electronic magnification process, or the like; and furthermore, information on whether or not the template image for the synthesizing process has been used, the kind of the template image used, or the like; are recorded in the information recording section 19 as the operating information. Furthermore, the operating information at the time of the printing and outputting process, such as a frequency of the cutting operation of the cutter 53, a frequency of the rear side printing by the rear side printer 54, the driving motor operation time of the conveyance roller, a frequency of the treatments with a developing agent, a fixing agent, or the like, an amount of the photosensitive material A used, or the like, are recorded in the information recording section 19.

The operating means, such as the mouse 50 and the key board 48, can input various commands, such as the printing size, the number of prints, and the color/density correction. The mouse 50 is used for selecting an image displayed on the website, designating a position for inputting characters, or the like. The key board 48 is used for inputting customer information, an image attribute information, an image selecting signal, or the like. A dedicated inputting device comprising a pointing device function and a function that inputs numerical values, characters, or the like, can be used instead of the mouse 50 and the key board 48.

The display 44, displays an image read by the scanner section 12, a command for various operations, an image photographed by a camera, which will be described later, an image or notifying information transmitted from the call center, or the like. As the display 44, for example, a liquid crystal display, a cathode ray tube display, an EL display, a plasma display, or a television set can be used. Furthermore, a so-called touch panel comprising the functions of the mouse 50, the key board 48 and the display 24 can be used as well.

The network connection section 46 (transmitting means and receiving means) is for connecting with various networks such as a wide area network (WAN), and a local area network (LAN) represented by an Ethernet. The network connection section 46 comprises, for example, a modem, or the like, for connecting the control section 18 and the WAN via a communication line, and the software for connecting with the network.

The PC control section 51 transmits, for example, a command of the various conditions and processes for the image forming device 10, which were inputted by the mouse 50 or the key board 48, information for the settings, the customer information, the image selection signal, the image attribute signal, the various kinds of information received from the call center 82, or the like to the image forming device 10 via the interface 49. The PC control section 51 can designate the image data relating to the various kinds of information from the call center 82, or read out by the reading-writing drive 17 to be displayed on the display 44.

The client PC 90 is connected with the camera 92 and the microphone 94. As the camera 92, for example, a photographic device such as a digital camera or a digital video camera, can be used. The camera 92 can read an image, which was focused by lens groups, using an imaging element such as a CCD, to record this image as image data, that is, video information, in a recording medium such as a smart medium or a flexible disc, or in the information recording section 19 as the monitoring information. In this embodiment, the camera 92 can photograph the periphery of the image forming device 10, such as the installation environment of the image forming device 10 and a state of operation by a user of the image forming device 10. The photographed image is transmitted to the client PC 90 as the image data so that it can be confirmed on the display 44 of the client PC. Moreover, the photographed image can be transmitted as the video information (monitoring information) from the client PC 90 to the call center 82, via the network 88, so that this image can be confirmed by a PC 96 in the call center 82. The image confirmation can be executed substantially simultaneously with the photographing, that is, in real-time. Moreover, it can be executed while refering to the operating information.

The microphone 94 can collect and record the sound in the vicinity of the installation site of the image forming device 10, such as the voice of the user, and operating noises of the image forming device 10. The sounds, which are collected or recorded, are transmitted to the client PC 90 as the monitoring information of the sound information so that it can be reproduced via a speaker (not shown) of the client PC. Moreover, the sound information can be transmitted from the client PC 90 to the call center 82 via the network 88 so that it can be heard at the call center 82.

Furthermore, the client PC 90 is connected with a sensor 91. The temperature and the humidity in the installation environment of the image forming device 10 can be measured at constant intervals by the sensor 91, and further, whether or not there is a vibration, the size of the vibration, or the like can be sensed at constant intervals: these can be recorded as the operating information in the information recording section 19.

The call center 82 is connected with the photo-shop 80 via the network 88, through which the image forming device 10 can be managed and problem therein can be diagnosed. The call center 82 comprises the personal computer (hereinafter referred to as the PC) 96 and a network connection section 98.

The PC 96 comprises an unillustrated memory, which stores a program for management and diagnosis of the image forming device 10 and a program for managing and controlling the whole call center 82. The PC 96 administers and controls the call center 82 according to the programs stored in the memory and displays the operating information and the monitoring information on an unillustrated display. Moreover, the PC 96 relates and attaches the coping information for dealing with the operating information and the monitoring information, which are transmitted from the client PC 90, and stores the coping information in the information table. Then, the coping information can be delivered from the information table to the image forming device 10. Furthermore, the PC 96 administers and diagnoses the image forming device 10 in the photo-shop 80 based on the monitoring information, including the operating information of the image forming device 10, the operating noise of the image forming device 10, the user's voice, the image data, or the like, received from the photo-shop 80.

Specifically, PC 96 transmits to the photo-shop 80 predetermined notifying information based on the operating information, or the like, received from the photo-shop 80. Moreover, by referring to the monitoring information, which includes the image photographed by the camera 92 of the photo-shop and the like, the operator monitors and grasps the operation state of the image forming device 10. Furthermore, according to necessity and the state of the image forming device 10 based on the monitored and grasped information, the coping information is retrieved and transmitted from the PC 96 of the call center 82 as the information for solving the trouble. Since the image can be referred to in real time, the operator can monitor and grasp the user's operation state of the image forming device 10 while staying at the call center 82. Moreover, when the operation abnormal state or the operation inoperable state occurs in the image forming device 10, by referring to the image data and the operating information, it can be confirmed whether or not the cause of the operation abnormal state or the operation inoperable state is derived from the user's wrong operation.

The network connection section 98, which is the transmitting means, connects the PC 96 with various kinds of networks comprising the network 88, such as the wide area network (WAN), and the local area network (LAN).

As the network connection section 98, a modem for connecting with the WAN, a router, and the Ethernet card for connecting to the LAN, or the like can be adopted. Moreover, a program for connecting with the network 88 is stored in the personal computer 96. The call center 82 receives the operating information and the error information for the image forming device 10 from the client PC 90 of the photo-shop 80 and transmits predetermined information corresponding to the image forming device 10 as needed. Moreover, the call center 80 transmits command information for automatic operations and the process for the management and the diagnosis.

The PC 96 of the call center 82 is connected with a camera 93 and a microphone 95. Similar to the above-mentioned camera 92, as the camera 93, for example, a photography device such as a digital camera and a digital video camera can be used and the periphery of the PC 96, such as the operator of the call center 82 can be photographed by the camera 93. The photographed image can be transmitted to the PC 96 as the image data so that it can be confirmed on the display (not shown) of the PC 96 and can be transmitted to the photo-shop 80 from the PC 96 via the network 88.

The microphone 95 can collect and record the sound in the call center 82, such as the voice of the operator. The collected and recorded sound is transmitted to the PC 96 so that it can be reproduced via a speaker (not shown) of the PC 96 and can be transmitted to the photo-shop 80 from the PC 96 via the network 88.

The machinery retail shop 84 executes sales of the image forming device 10 to the photo-shop 80 and manages version upgrades, and the like, for the programs stored in the image forming device 10. The machinery retail shop 84 manages the programs for controlling the whole image forming device 10, the version upgrade information of the various kinds of the programs, such as the image processing program, and the upgraded program so that the information and the programs can be transmitted to the photo-shop 80.

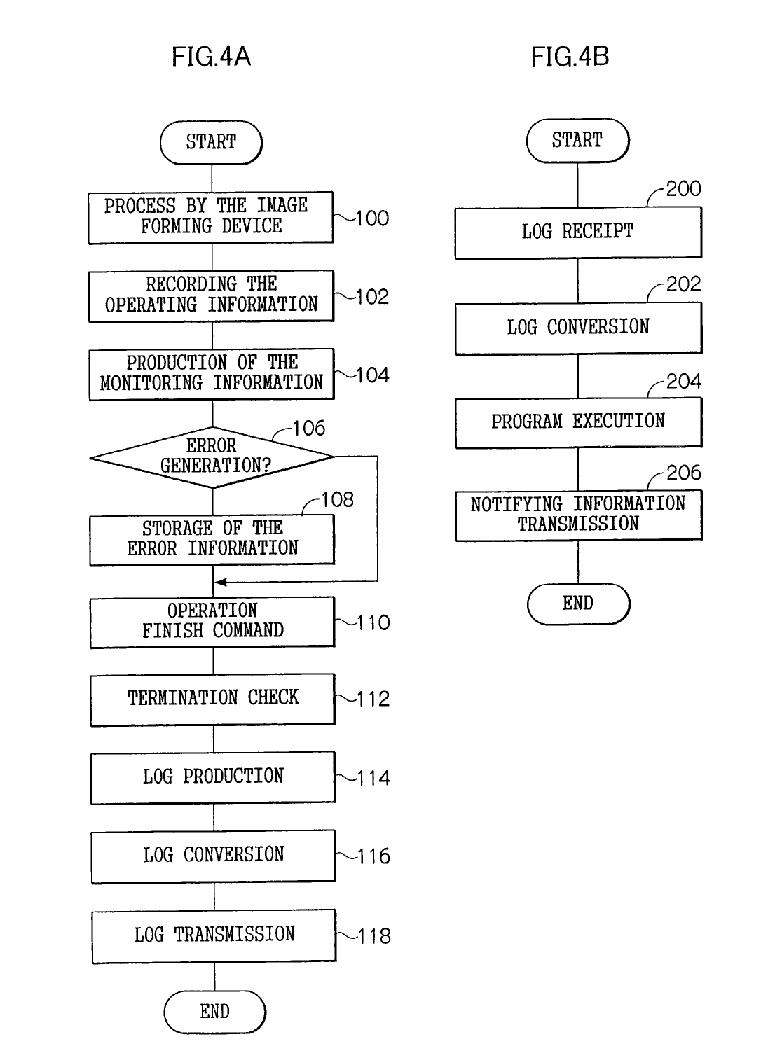

Hereinafter, the management method for an image forming device according to the management system for an image forming device of this embodiment will be explained with reference to the flow chart of FIG. 4.

In step 100 of FIG. 4A, a process for the photographic printing of the image recorded on a film, or the like is started by the image forming device 10 and proceeds to step 102. In the next step 102, in the above-mentioned series of the process, the following information is recorded as the operating information in the information recording section 19. For example, in reading the image in the scanner section 12, the kind of the light source 20, the length of light emission time, the electric current value at the time of the light emission, or the like are recorded. In the image process of the image processing section 14, the frequency of the image processes used, whether or not the template images was used, or the like, are recorded. Moreover, in the image output in the printer section 16, the frequency of the operation of the cutter 53, the frequency of the printing operation, the operation time of the driving motor as the drive source of the conveyance roller that conveys the photosensitive material A, the amount of the photosensitive material A used, and furthermore, the output information, such as the image data supplier information, the kind of the image size of the outputted image, and the size of the outputted image data are recorded.

Furthermore, in step 104, the temperature, the humidity, whether or not there is the vibration and the size thereof, or the like, in the installation environment of the image forming device 10 in the series of the processes are measured over a constant interval and the measurement result is stored as the operating information in the information recording section 19. Moreover, in the above-mentioned series of processes, the user's operation state is photographed by the camera 92, the photographed image is transmitted to the client PC 90 as the image data and recorded as the video information (monitoring information) in a predetermined recording medium such as a smart medium or in the information recording section 19. Additionally, simultaneous with the photographing of the user's operation state, the voice of the user, the operating noise of the image forming device 10, or the like are recorded by the microphone 94, the recorded sound is transmitted to the client PC 90 as the sound information (monitoring information) and recorded in a predetermined recording medium or in the information recording section 19.

Furthermore, in a next step 108, it is judged whether or not an error, which does not lead to a process stoppage, was generated in the above-mentioned series of processes. If the judgment is positive, that is, it is judged that an error not leading to a process stoppage (an operation abnormal state) was generated, for example, an error, such as the electric current value of the light source 20 being under the tolerance limit, or an inability to cut the photosensitive material A by the cutter 53, was generated, then a time of the error generation, an error generated site, the error state, or the like are stored in the step 108 in the information recording section 19 as the error information. When the judgment in the step 106 is negative, that is, it is judged that an error was not generated, the process progress to step 110.

Accordingly, if the print outputting process by the image forming device 10 is finished and the operation finishing command for the image forming device 10 is provided by the user in the step 110, the process moves to step 112 and starts the termination check of the image forming device 10 before finishing the operation instead of immediately finishing the operation. In the termination check, the various setting values of the image forming device 10 and the components are returned to the initial state. Moreover, when the process has completed the return to the initial state of the setting values, or the like, it moves to step 114 and records, in the information recording section 19, the operating information and the error generated information from the start of the operation of the image forming device 10, the image data as the photographed user's operation state and the operation sound, the monitoring information as the sound data obtained by recording the user's voice, or the like, data of the temperature, the humidity, or the like are read out from the information recording section 19 so that the operation log including the operating information and the monitoring information is produced in the control section 18. Simultaneous with the production of the operation log, if it was judged that an error had been generated in the step 106, an error long including only the error generated information is produced.

The operation log and the error log are converted automatically to a binary format in step 116, and furthermore, they are transmitted to the call center 82 via the network connection section 46 in step 118.

FIG. 4B shows a process in the call center 82. In step 200 of FIG. 4B, the PC 96 of the call center 82 receives the operation log and the error log. The received operation log and the error log are converted from the binary format in step 202 and returned to the operating information and the monitoring information. When the conversion is finished, the process progresses to step 204 and a predetermined management and diagnosis program is executed in the PC 96.

According to the management and diagnosis program, based on the converted operating information and monitoring information, and the error generated information, the state of the image forming device 10 is judged. If the operation abnormal state or the operation inoperable state is generated, the generation site and a cause of the generation of the operation abnormal state or the operation inoperable state are analyzed as needed to retrieve the coping information as the information of an appropriate coping method.

For example, when the error generated site of the operation abnormal state is the light source 20, the cutter 53, the drive motor for the conveyance roller in the printer section 16, or the like, the light emission time of the light source 20, the frequency of operation of the cutter 53, and the operation time of the drive motor for the conveyance roller in the printer section 16 are judged from the operation log and analyzed. Thereby, judgment can be made that for example, the parts in the generation site exceed an operation frequency limit or an operation time limit, or the replacement time of the parts in the site is approaching since it is close to the operation frequency limit or the operation time limit, or no abnormality is found in the parts. Furthermore, being able to judge the generation of the breakage of the components, or the like, by predicting the deterioration of the parts, the information for the coping method therewith can be retrieved.

Moreover, in addition to the operating information, from the state of the printed and outputted photosensitive material, the state of the reduction of the developing agent, the fixing agent, or the like, and the replacement time can be judged so that the information on the coping method can be retrieved according to this judgment.

Furthermore, from the operating information and the monitoring information, for example, whether or not the user performed a wrong operation at the time the operation abnormal state or the operation inoperable state was generated, whether or not the user applies an inadvertent shock to the image forming device 10, or the like can also be judged, and thus, it can be judged whether or not the cause of the operation abnormal state or the operation inoperable state is derived from a factor, which is external with respect to the image forming device 10. Then, according to this judgment, the coping information can be retrieved as an appropriate coping method.

Next, in step 206, the coping information retrieved by the PC 96 is transmitted to the client PC 90 as the notifying information to the photo-shop 80. In the notifying information, the command information requiring a cleaning or a checkup of the parts comprising the parts of the image forming device 10, an alarm information notifying the approach of the replacement time of the components, or the like can also be included.

According to this embodiment, by photographing the user's operation state, or the like, of the image forming device 10 by the camera 92 and transmitting the photographed image to the call center 82 as the image data, the operator in the call center 82 can grasp the user's operation state of the image forming device 10 by the image or the sound. Thus, when the operation abnormal state or the operation inoperable state is generated in the image forming device 10, the kinds of information and the amount of information for analyzing the cause of the operation abnormal state or the operation inoperable state are increased. Therefore, the cause of the operation abnormal state or the operation inoperable state from the user can be analyzed quickly and accurately without needing to dispatch a servicing personnel, who knows the configuration and the operation methods of the image forming device 10 very well, and the generation of the operation abnormal state or the operation inoperable state can be dealt with quickly and accurately. The operation state of the image forming device can be grasped by receiving an image obtained by photographing the periphery of the installation environment of the image forming device 10 by the PC 96 of the call center 82 consecutively as image data substantially simultaneous with the progress of the process of the image forming device so that the unmanned operation of the image forming device, and the unmanned drive of the photo-shop can be enabled.

Moreover, since the user of the image forming device 10 and the operator of the call center 82 can communicate remotely via the camera 92, the microphone 94, the client PC 90, the network 88, the PC 96, the camera 93 and the microphone 95, the user can convey the present state of the image forming device 10 by the sound and the image. Thus, the operator can judge the coping method for the image forming device 10 based on the given information.

Moreover, since the trouble can be dealt with quickly and accurately by the communication, an instruction manual provided for the image forming device 10, or the like can be simplified.

[Second Embodiment]

Next, a second embodiment of the present invention will be explained. Since the second embodiment as the same configuration as that of the above-mentioned first embodiment, the configuration will not be explained. Hereinafter, the operation of the second embodiment will be explained for the part different from that of the first embodiment.

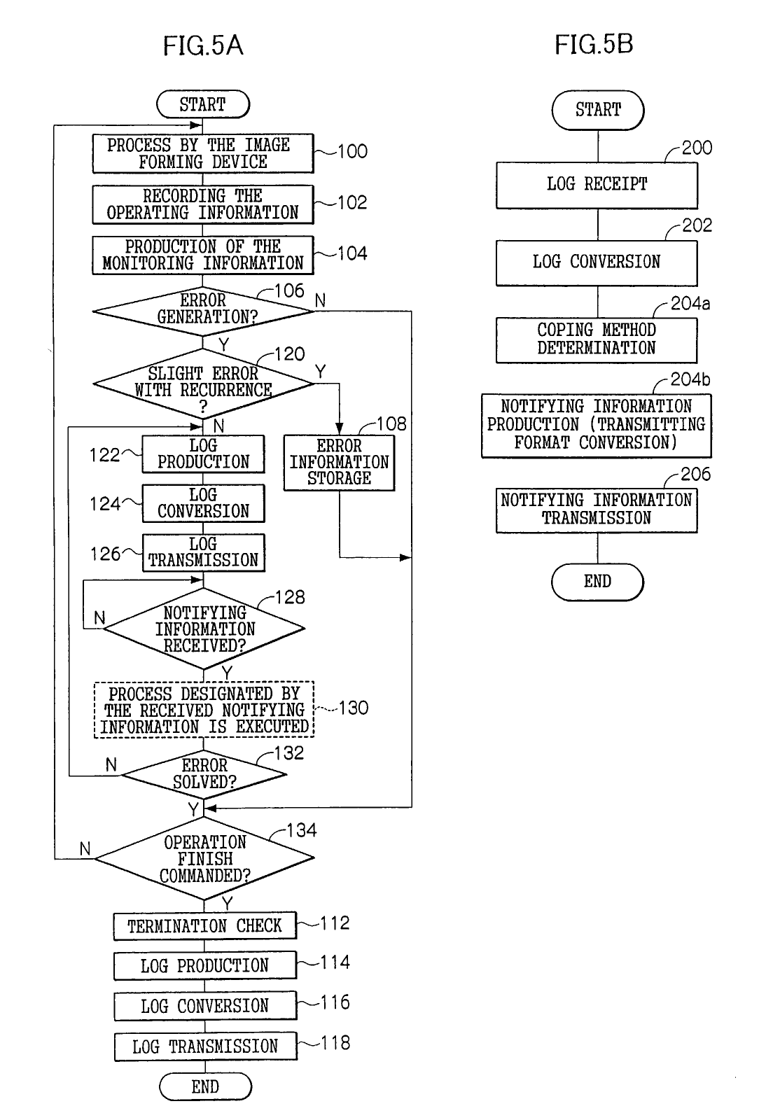

As shown in FIG. 5A, according to the management method for an image forming device 10 of the second embodiment, as in the first embodiment, first, the process for producing the photographic print from an image recorded in a film, or the like is executed by the image forming device 10 (step 100). Then, operating information is recorded in a predetermined recording medium or the information recording section 19 (step 102), and furthermore, monitoring information is recorded in the predetermined recording medium or the information recording section 19 (step 104). Thereafter, whether or not an error is generated in the image forming device 10 is judged (step 106). The error referred to herein includes any kind of errors such as an error leading to a process stoppage of the image forming device 10, an error lowering output quality, for example, but not leading to the process stoppage (operation abnormality), or the like.

In the case when the judgment in the step 106 is negative, the process procedure progresses to step 134 so that whether or not the operation termination of the image forming device 10 is commanded by the user is judged. In the case the judgment is also negative, it is returned to the step 100. Therefore, as long as the image forming device 10 is driven and an error is not generated in the image forming device 10, the process in the image forming device 10 and a recording operation for the operating information and the monitoring information are continued.

In the case when an error is generated in the image forming device 10, a positive judgment is made in the step 106 so that the procedure progresses to step 120 for judging whether or not the generated error is a slight (not leading to the process stoppage) and/or a recurring error. The type of the error is represented by an error code. Herein, the recurring error denotes a situation wherein an abnormal phenomenon reoccurs every time a certain operation is performed, and errors having the same error code, or errors having different error codes but occurring in the same order, are generated every time the certain operation is performed. Examples of the recurring error include output of the same kind of abnormal image, generation of the same kind of abnormal sound, generation of jamming at the same point, and generation of the same kind of poor communication.

Judgment in the step 120 can be executed based on, for example, the error code representing the kind of the generated error. Specifically, it can be realized by preliminarily registering the error code of a slight and recurring error, and judging whether or not the error code of the generated error is registered. Moreover, in the case the generated error is an error without the error code, not to be classified, the above-mentioned judgment is made to be negative.

In the case the error generated in the image forming device 10 is a recurring and slight error, the judgment in the step 120 is positive so that similar to the first embodiment, the error generation date, the error generation site, the error state, or the like are stored as the error information in the information recording section 19 in the step 108, and the procedure progresses to the step 134.

In contrast, in the case when there is a possibility that the error generated in the image forming device 10 is an non-recurring error, the judgment in the step 120 is negative so as to progress to the step 122. Examples of the non-recurrable error include: errors which may complicate investigation into the cause thereof by resetting information, which is potentially useful to investigate the cause of the error, when the image forming device is restarted; and serious errors, such as errors requiring the process stoppage or errors which make stopping the process preferable. After stoppage of the process in the image forming device 10, similar to step 114 to step 118 described in the first embodiment, the operation log and the error log are produced (step 122), the produced operation log and the error log are converted into the binary format (step 124) so as to be transmitted to the call center 82 via the network connection section 46 (step 126). Moreover, in the following step 128, whether or not the notifying information from the call center 82 is received is judged so that the step 128 is repeated until the judgment becomes positive.

Accordingly, in this embodiment, when a non-recurrable error is generated in the image forming device 10, since the process in the image forming device 10 is stopped so that the restart of the image forming device 10, or the like is not executed at least until the notifying information is received, information potentially useful to investigate the cause of the error generation, such as the information stored in the memory of the image forming device 10, or the like can be maintained without the risk of erasure by the restart of the image forming device 10, or the like.

As shown in FIG. 5B, at the call center 82, as in the first embodiment, the operation log and the error log are received by the PC 96 (step 200) so that the received operation log and error log are converted from the binary format to the original format (step 202). Moreover, by executing a predetermined management and diagnosis program in the PC 96, the state of the image forming device 10 can be judged based on the operation log and the error log so that in the case the operation abnormal state or the operation inoperable state is generated, the generation site and the generation cause of the operation abnormal state or the operation inoperable state are analyzed. Then, based on the analysis result of the generation site and the generation cause, the coping information representing an appropriate coping method for the generation site and the generation cause can be retrieved from the coping information preliminarily registered by a large amount so that the coping method for the operation abnormal state or the operation inoperable state can be determined with the retrieval result taken into the consideration (step 204a).

The coping method can be determined not only by automatic retrieval of the coping information but also by the operator of the call center 82 based on the operation log or the error log particularly in the case the generated error is potentially a non-recurring error, the generated error is a serious error, or the like. For example, in the case a serious error is generated, errors having the different kinds of error codes may be generated successively, however, even in the case the generated errors are same, the coping method can be varied depending on the generation order of the errors. Accordingly, since the coping method can hardly be determined automatically in the case errors of a plurality of kinds are generated successively, an error not to be classified by the error code is generated, or the like, information concerning the generated error is noticed to the operator so that the coping method is determined by the operator.

In the case the coping method is determined as mentioned above, the coping information representing the determined coping method is converted according to the format for transmitting information to the client PC 90 of the photo shop 80 so as to produce the notifying information (step 204b), and the produced notifying information is transmitted to the client PC 90 (step 206).

In the case the error generated in the image forming device 10 is a non-recurrable, or the generated error is a serious error, when the notifying information from the call center 82 is received as mentioned above, the judgment in the above-mentioned step 128 is made positive so that the procedure progresses to the step 130, and the process designated by the received notifying information is executed by the user.

In the following step 132, whether or not the error is solved by the measure executed in the step 130 is judged. In the case the judgment is positive, the procedure progresses to the step 134. In the case the judgment is negative, it returns to the step 122 so that the process in the step 122 and thereafter is repeated.

Thus, by repeating the steps 122 to 132 multiple times, the generated error can be solved, even when a single coping operation cannot identify the cause of this error or does not solve the error.

Moreover, according to the second embodiment, even in the case when the error generated in the image forming device 10 is non-recurrable, since the image forming device 10 is not restarted in the step 130 until the restart of the image forming device 10 is commanded as the coping method, the operator of the call center 82 can investigate the cause of the error generation, or the like based on the information stored in the image forming device 10, which information is potentially useful to investigate the cause of the error generation.

Since the process after positive judgment in the step 134 by commanding the operation finish of the image forming device 10 by the user is same as that of the first embodiment, further description is not given.

As heretofore explained, according to the invention, in the case of generation or the operation abnormal state, or the like, of the image forming device, it can be dealt with quickly and accurately so that the excellent effect of reducing the period for analyzing the cause of the operation abnormal state and the operation inoperable state and repairing the image forming device, can be provided.

What is claimed is:

1. A management method for an image forming device for managing an image forming device, which forms an image based on inputted image data, by a management device connected therewith via a communication line, comprising the steps of:
recording operating information in a recording medium, which operating information shows an operation state of the image forming device;
monitoring the image forming device from outside the image forming device and collecting monitoring information;
transmitting the operating information and the monitoring information to the management device via the communication line; and
managing the image forming device based on the received operating information and monitoring information.

2. The method of claim 1, wherein the monitoring information is information corresponding to the operating information.

3. The method of claim 1, the operating information further comprising an operation history formed by data representing the operation state of a plurality of items for a predetermined time period, as a unit information.

4. The method of claim 2, the operating information further comprising an operation history formed by data representing the operation state of a plurality of items for a predetermined time period, as a unit information.

5. The method of claim 1, the operating information further comprising error generated information, which is generated in the image forming device.

6. The method of claim 2, the operating information further comprising error generated information, which is generated in the image forming device.

7. The method of claim 1, wherein the monitoring information comprises at least one of sound information and video information obtained by monitoring the image forming device.

8. The method of claim 2, wherein the monitoring information comprises at least one of sound information and video information obtained by monitoring the image forming device.

9. The method of claim 1, the managing step further comprising a step of outputting coping information concerning a treatment to be executed in the image forming device, based on the received operating information and monitoring information.

10. The method of claim 9, the managing step further comprising a step of transmitting the coping information from the management device to the image forming device.

11. A management system for an image forming device that forms an image based on inputted image data, for managing the image forming device by a management device connected therewith via a communication line, the system comprising:
(1) a terminal device disposed at the image forming device, the terminal device including:
recording means for recording operating information, which shows an operation situation of the image forming device,
monitoring information collecting means for collecting monitoring information, which is obtained by monitoring the image forming device from the outside and made to correspond to the operating information,
transmitting means for transmitting the operating information and the monitoring information to the management device via the communication line; and
(2) a management device including:
receiving means for receiving, via the communication line, the transmitted operating information and monitoring information, and
storing means for storing the received operating information and monitoring information.

12. The management system of claim 11, the management device further comprising a display means for displaying the received operating information and monitoring information.

13. The management system of claim 11, wherein the recording means records, as the operating information, an operation history, which is formed by data representing the operation state of a plurality of items for a predetermined time period, as a unit information.

14. The management system of claim 11, wherein the storing means of the management device stores, as the operating information, an operation history, which is formed by data representing the operation state of a plurality of items for a predetermined time period, as a unit information.

15. The management system of claim 11, wherein the recording means records, as the operating information, error generated information, which is generated in the image forming device.

16. The management system of claim 11, the monitoring information collecting means comprising at least one of sound information collecting means for collecting sound information and video information collecting means for collecting video information.

17. The management system of claim 11, the management device further comprising coping information outputting means for outputting coping information concerning a treatment to be executed in the image forming device, which coping information is based on the received operating information and monitoring information.

18. The management system of claim 17, wherein the terminal device further includes information receiving means for receiving information via the communication line, and the management device further includes transmitting means for transmitting the coping information to the terminal device.

19. The management system of claim 18, wherein the coping information further includes operation information for operating the image forming device, and the terminal device comprises operating means for operating the image forming device based on the operation information.
